(19) United States
(12) Patent Application Publication
(10) Pub. No.: US 2009/0219247 A1
(43) Pub. Date: Sep. 3, 2009

(54) FLEXIBLE INFORMATION DISPLAY TERMINAL AND INTERFACE FOR INFORMATION DISPLAY

(75) Inventors: Junichiro Watanabe, Tokyo (JP); Arito MOCHIZUKI, Musashino (JP); Tadaaki ISHIKAWA, Tsuchiura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/365,192

(22) Filed: Feb. 4, 2009

(30) Foreign Application Priority Data
Feb. 29, 2008 (JP) 2008-049017

(51) Int. Cl. G06F 3/033

(52) U.S. Cl. 345/157

(57) ABSTRACT

An information display terminal includes a flexible display unit that displays information and is configured to be flexible; bend sensors that are incorporated in the display unit and detect a bending degree by bending the display unit; and an image display control unit that controls a scrolling speed of the information displayed on the display unit in accordance with a detection output of the bend sensor, wherein a page turn-over display of the information is performed at the scrolling speed in accordance with the bending degree of the display unit. The information display terminal provides an interface for performing content browsing in a virtual world with the same sense of reading an actual book.

### CLAIM OF PRIORITY

The present application claims priority from Japanese patent application JP 2008-049017 filed on Feb. 29, 2008, the content of which is hereby incorporated by reference into this application.

### FIELD OF THE INVENTION

The present invention relates to an information display device such as a television, a portable information terminal, or the like, and an interface for information display used therefore.

### BACKGROUND OF THE INVENTION

Recently, various portable information terminals including a cellular phone have spread. For example, a large number of music files are installed in a small-sized portable music player with a high-capacity hard disk, such that it is possible to enjoy music regardless of a place or time. Alternatively, in addition to the music, a large number of still image files or moving picture files are also installed in the portable information terminal, whereby it is possible to enjoy the music similarly. In addition, the portable information terminal that has communication members such as a wireless LAN, etc. is used as a standard. Still larger amount of digital contents can be seen and heard by streaming and downloading through the Internet in addition to digital contents such as music, still images, moving pictures, etc. that are stored in a local storage by accessing such an information terminal. Furthermore, a portable terminal for receiving an Internet-used television broadcasting (IP-TV) has spread and a large quantity of television programs can be seen and heard.

Meanwhile, a technology relating to an electronic paper, as an information display device, is being developed. The electronic paper should have low power consumption while displaying information and may have low power consumption even in rewriting the information. Like paper, since the electronic paper performs a display using reflected light, the electronic paper has a wide viewing angle and is easy to view even though the electronic paper is exposed to direct sunlight. Although the electronic paper has had a problem in that a response speed is slow for displaying the moving pictures, the response speed has increased by technological development in recent years. Further, a flexible display, which is an electronic paper of which a display surface can be flexibly bent, has been also invented. When the flexible display is put to practical use, an information display terminal having very excellent portability can be realized. For example, a technology that fast-forwards display images by bending a display device is disclosed in JP-A-2006-344217.

As a portable information terminal has multiple functions and high functionality, and the volume of information to which users access increases, the complexity of an operation until desired contents are found also increases. As a means for operating the portable information terminal, for example, a plurality of buttons or a plurality of touch panels are generally operated. For example, when a desired content is searched from a large amount of photograph data, the desired content is searched scrolling a list by pressing left and right buttons of the portable terminal using left and right forefingers. The scrolling maybe performed at a predetermined speed or while accelerating a speed by pressing the button for a predetermined time. In operating the touch panel, the scrolling is performed by touching the surface of a screen using fingers. Besides a case in which the desired content is searched from a thumbnail list, the same operation can be performed even in a case in which an image is searched while scrolling images arranged in a row like a slide show.

In the operation methods, a scrolling distance depends on the number of times at or a time to press the button is pressed, or a distance or a length of time to drag the screen by the tip of the finger. Therefore, when a content that is separated from an image which is currently seen by a long distance is searched, the desired content is searched by switching from the long-time pressing operation into a one-time pressing operation after moving to the vicinity of the desired content by scrolling the screen at an approximate distance by pressing long the button. As a result, two kinds of movements such as a fast movement by the long-time pressing operation and a one-frame movement by the one-time pressing operation are dividually performed. Therefore, until the desired content is finally found, the long-time pressing operation and the one-time pressing operation need to be performed several times, such that the operations are inconvenient particularly in a case in which the number of contents is large. In the case of operating the touch panel, display contents are generally scrolled only by dragging a display screen using the finger. The scrolling can be performed by using inertia, but the number of times to drag the screen by the finger basically contributes to the scrolling distance. As a result, as described as the example of the button operation, since the display screen needs to be dragged using the finger several times in a case in which the scrolling having a long distance is performed, there is no problem in the case of moving individual contents while the button operation is not suitable for scrolling a large quantity of contents.

For example, when a desired photograph is found while a large quantity of photograph contents are accessed, other photographs are frequently and continuously searched while the position of the photograph is remembered. A known portable information terminal has a function to register the desired content as a bookmark. However, the content is stored in a bookmark list and the book mark list other than a screen of a photograph list which is currently searched is displayed and the desired content is selected from a plurality of desired contents in order to display a desired content. Therefore, there cannot be achieved good operationality that the user continuously turns over pages by a user's finger placed on a liked page found while turning over the pages of an actual book and returns to the page where the finger is placed at any time.

A portable information terminal (hereinafter, referred to as “electronic book”) exclusively for reading electronic books is sold as a product. In the electronic book, book contents are displayed on a display and pages are continuously turned over by pressing buttons or touching a screen with a stylus pen. However, because the pages are turned over by pressing the buttons or touching the screen, the electronic book greatly has an operation sense greatly different from a sense to operate the actual book. Further, the electronic book has a function (bookmark function) to memorize the page when reading is interrupted. However, this function is essentially the same as the above-mentioned bookmark function and the number of a page where the reading will be restarted is selected from a plurality of page numbers registered in the bookmark list to restart the reading. As a result, it is difficult to implement easiness that the reading is restarted by opening a part where the finger or the bookmark is placed similar to opening the actual book. Further, when the bookmark is placed in the liked page, that is, the page is registered in the bookmark list, an input operation needs to be performed by opening a screen exclusively for registration, such that successive operations of inserting the bookmark and turning-over the pages are not rapidly performed.

A function similar to the bookmark function includes a chapter function of a DVD recorder, etc. In this function, by marking a predetermined image frame during reproducing the moving picture file, it is possible to move a reproduction position to the marked image frame. A button of ‘Add Chapter’ on a remote controller is pressed in order to perform this operation. At this time, a plurality of other buttons such as ‘Fast Forward’, ‘Rewind’, ‘Frame Advance’, etc. need to be operated until a marked part to be displayed is finally determined. As a result, it is difficult to rapidly perform an operation such as the continuation of the insertion of the bookmark and the turning over of the pages (i.e., the continuation of seeing and hearing the moving picture) similar to how the actual book is treated.

A portable information terminal using “Book Metaphors” as software is marketed. Free software that is distributed free of charge may be included in them. In these applications, a GUI (Graphical User Interface) that imitates the book is displayed on a PC screen and contents such as the still images, etc. are displayed on the pages of the book. Browsing the contents is performed by turning over the pages of the book within the screen. The pages of the book on the screen are turned over by dragging the pages with a mouse, clicking a right end or a left end of the screen, or pressing left and right arrow keys of a keyboard. However, an operation using the mouse or the keyboard that is designed to operate a computer is different from an operation using the actual book. For example, it is difficult to perform an operation for turning over the pages while freely controlling the turning over speed or the number of pages.

An information display part of the above-mentioned known portable information terminal is made of an inflexible material such as plastic, glass, acrylic, or the like. On the contrary, the actual book is made of paper, the turn-over speed of the pages are freely controlled by bending the book itself which is a display medium or a liked page can be opened at any time by placing the finger between the pages.

As an electronic information display device, the technological development of a flexible display of which a display surface itself can be bent has progressed. In order to put the flexible display into practical use, an operation method or an interface other than the interface suitable for the known information terminal of which the display surface is not flexible, such as the button operation or the touch panel operation is required.

### SUMMARY OF THE INVENTION

A first object of the present invention is to provide an interface that can solve the above-mentioned problems and enables browsing digital contents by a sense to treat an actual book and/or an information display device with the same.

A second object of the present invention is to provide an interface suitable for a flexible display which a flexible display and/or an information display device with the same.

A third object of the present invention is to provide an interface that has a function to perform contents browsing such as scrolling, etc. by bending a display itself so as to be suitable for a flexible display such as a flexible display, etc., promptly memorize a specific content found during the content browsing, and display the contents at any time while continuously operating the contents browsing and/or an information display device with the same.

In order to achieve the above-mentioned objects, according to an aspect of the present invention, there is provided a flexible information display terminal that can quantitatively acquire a bending condition at the time of bending a display itself and can perform a search while arbitrarily and continuously adjusting a scrolling speed in accordance with the bending condition.

Further, it is possible to adjust the scrolling speed of contents displayed on a display at a speed depending on the bending condition.

Further, in case of performing the scroll by bending the display or in case of flattening the display by stopping the bending, it is possible to memorize the then displayed contents by pressing a button or a switch.

According to the aspect of the present invention, it is possible to grant a bookmark to a predetermined content without hindering content browsing such as the scroll, etc.

In addition, by using an interface according to a second aspect of the present invention, when a page to which the bookmark is granted is searched, it is possible to perform the search while continuously and arbitrarily the scrolling speed by the bending condition, such that it is possible to prevent an useless operation such as pressing a plurality of another buttons, etc.

By using the interface according to the aspect of the present invention, it is possible to browse digital contents in the same feeling of turning over pages of an actual book in a device having a display itself is flexible, such as a flexible display. As a result, all users who access vast amounts of information easily and intuitively.

### BRIEF DESCRIPTION OF THE DRAWINGS

FIG. 1 is a diagram illustrating an entire configuration showing the outline of a system an embodiment of the present invention;

FIG. 2 is a diagram illustrating one configuration example of a portable information terminal according to an embodiment of the present invention;

FIG. 3 is an exploded perspective view illustrating one configuration example of a portable information terminal according to an embodiment of the present invention;

FIG. 4 is a diagram illustrating a state in which a portable information terminal is bent and held according to an embodiment of the present invention;

FIGS. 5A to 5F are diagrams illustrating an example of a screen scroll by bending a portable information terminal according to an embodiment of the present invention;

FIG. 6 is a flowchart illustrating a screen scroll by bending a body of a portable information terminal according to an embodiment of the present invention;

FIG. 7 is a diagram illustrating one example of a bookmark function according to an embodiment of the present invention;

FIG. 8 is a diagram illustrating a bookmark function using a portable information terminal according to an embodiment of the present invention;

FIG. 9 is a flowchart illustrating a case when a bookmark function is performed by using a portable information terminal according to an embodiment of the present invention;

FIG. 10 is a diagram illustrating one example of stopping and restarting a scroll according to an embodiment of the present invention;

FIG. 11 is a diagram illustrating a state in which a terminal is held when stopping and restarting a scroll are performed according to an embodiment of the present invention; and

FIG. 12 is a flowchart illustrating a case when the scroll is stopped and restarted according to an embodiment of the present invention.

### DETAILED DESCRIPTION OF THE PREFERRED EMBODIMENTS

Hereinafter, an embodiment of the present invention will be described with reference to the accompanying drawings.

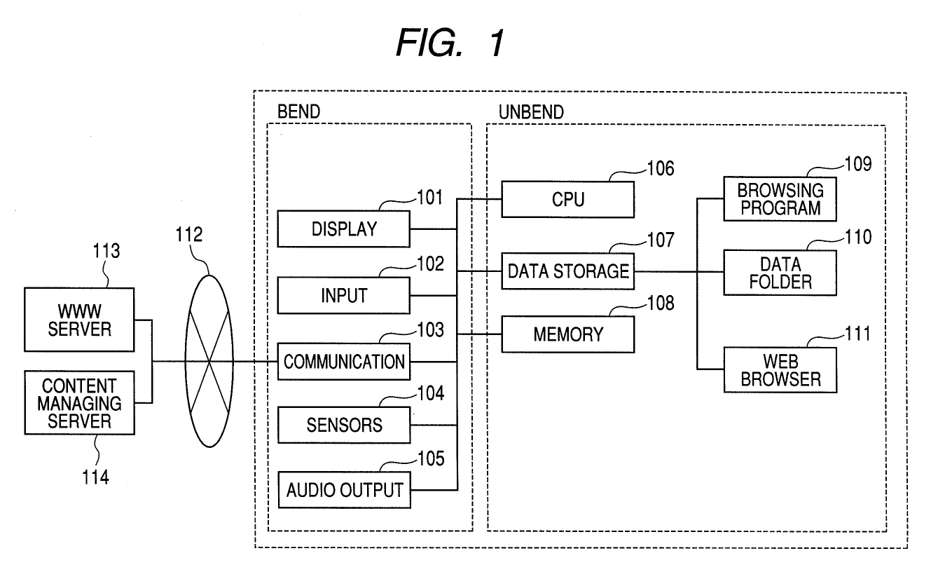

FIG. 1 is a schematic block diagram illustrating an embodiment of the present invention. Reference numeral 101 represents a display unit, reference numeral 102 represents an input unit, reference numeral 103 represents a communication unit, reference numeral 104 represents a sensor information reading unit, reference numeral 105 represents a audio output unit, reference numeral 106 represents a CPU, reference numeral 107 represents a data storage such as a hard disk, etc., reference numeral 108 represents a memory unit, reference numeral 109 represents an browsing program, reference numeral 110 represents a data folder, reference numeral 111 is a Web browser, reference numeral 112 represents an Internet network, reference numeral 113 represents a WWW server, and reference numeral 114 represents a content server. A terminal device according to an embodiment of the present invention includes the display unit 101, the input unit 102, the communication unit 103, the sensor information reading unit 104, the audio output unit 105, the CPU 106, the data storage 107 such as the hard disk, etc., the memory unit 108, the browsing program 109, the data folder 110, and the Web browser 111. The Internet network 112, the WWW server 113, and the content server 114 are separated from the terminal device.

In this figure, an interface according to an embodiment of the present invention accesses digital contents such as still images, moving pictures, music, etc. that are stored in the data folder 110 of the hard disk 107 by means of the browsing program 109 or accesses external digital contents that are stored in the WWW server 113 or the content managing server 114 via the Internet 112. Programs of IP-TV, etc. or moving picture data, etc. containing additional information such as texts, etc. may be included in the content managing server 114 besides the still images, the moving pictures, the music, etc.

The browsing program 109 is stored in the data storage 107 such as the hard disk, etc. together with the data folder 110. When the CPU 106 starts the browsing program 109, the digital contents stored in the data folder 110 are displayed on the display unit 101. Further, when the Web browser 111 is started, the contents that are provided by the WWW server 113 or the content managing server 114 are displayed on the display unit 101 via the Internet 112.

In a case in which the still images, the moving pictures, the music files, etc. are browsed in the browsing program 109 or the Web browser 111, for example, an operation of scrolling the still images needs to be performed, but in the interface according the embodiment of the present invention, the sensor information reading unit 104 detects a bending condition of the display unit 101 itself and the CPU 106 processes a value of the bending condition, whereby a scrolling speed is determined in accordance with the value.

The value read by the sensor information reading unit 104 is received from a bend sensor that can detect the bending condition of the display unit 101 itself mounted on a portable information terminal with the interface according to the embodiment of the present invention and is information on the bending condition when a terminal body, i.e., the display unit itself is bent.

The interface according to the embodiment of the present invention acquires auxiliary input information other than the sensor information read by the sensor information reading unit 104 from the input unit 102. The auxiliary input information other than the sensor information includes, for example, binary information such as ON/OFF by using a button or a switch.

The audio output unit 105 gives the feedback of sound and vibration generated by an operation at the time of accessing the contents by means of the browsing program 109. For example, when accessing the still images by scrolling, the audio output unit 105 outputs sounds having different pitches depending on the scrolling speed and gives the feedback of the scrolling speed.

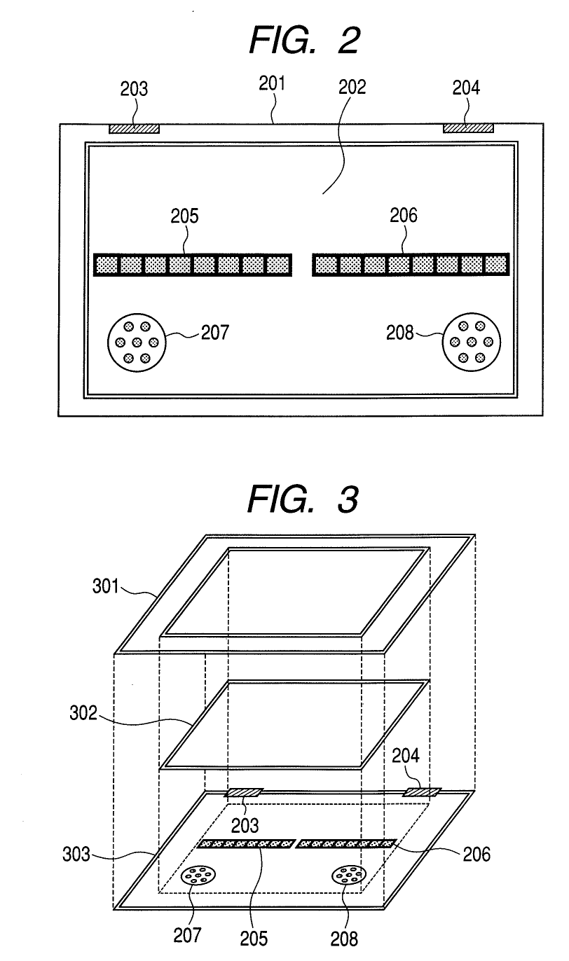

FIG. 2 illustrates an example of a portable information terminal using an interface according to an embodiment of the present invention.

In this figure, reference numeral 201 represents a terminal body, reference numeral 202 is a display, reference numerals 203 and 204 represent a button or a switch, reference numerals 205 and 206 represent bend sensors, and reference numerals 207 and 208 represent speakers. In this figure, the bend sensors 205 and 206 and the speakers 207 and 208 are overlapped with the display 202, but actually, the bend sensor 205 and 206 and the speakers 207 and 208 are mounted inside of the terminal body 201. The speakers 207 and 208 are exemplified as the audio output unit, but the sound may also be output by vibrating the display 202 itself and this method may be used.

In FIG. 2, the terminal body 201, the display 202, and the speakers 207 and 208 are made of a flexible material in addition to an electric circuit board, a battery, or the like. Therefore, it is possible to perform an operation by the bending, which is a main function of the interface according to the embodiment of the present invention. The terminal body 201 is configured by forming ceramic in a sheet shape and is made of the flexible material such as thin plastic, rubber, or the like. The display 202 is a flexible display which is a sheet-like display in which a structure of a light emitting element nipped with a film made of the plastic, etc. can be thinly bent, for example. The electronic circuit board includes a flexible print circuits (FPC) in which conductive ink is printed on a thin flexible sheet such as the film, etc., a flexible cable in which print-wiring is performed on a thin film and terminals are attached to both ends thereof, bendable electronic components (commonly called “flexible electronics”) such as flexible transistors, etc. The battery is composed of a flexible solar cell, etc. These are technologies that have been already realized. Further, in relation to the speaker, a technology using the flexible display itself as the speaker has been already been realized.

FIG. 3 is a diagram illustrating one detailed configuration example of the portable information terminal shown in FIG. 2. Reference numeral 301 represents an upper cover of the terminal body, reference numeral 302 represents the display, reference numeral 303 represents a lower cover, and reference numerals 203 and 204 represent the button or the speaker. The bend sensors 205 and 206 and the speakers 207 and 208 are disposed on the lower cover 303.

In this figure, the upper cover 301, the display 302, the lower cover 303, and an electric circuit or a sensor disposed thereon are made of a thin flexible material. For example, the upper cover 301 and the lower cover 303 may be made of thin plastic or rubber. Other flexible materials may be used. The display 302 is the flexible display which is a sheet-like display in which the structure of the light emitting element stuck with the film made of the plastic, etc. can be thinly bent, for example. The electronic circuit mounted on the lower cover 303 includes the flexible print circuit (FPC) in which the conductive ink is printed on the thin flexible sheet such as the film, etc., the flexible cable in which the print-wiring is performed on the thin film and the terminals are attached to both ends thereof, the bendable electronic components (commonly called “flexible electronics”) such as the flexible transistors, etc., and the flexible solar cell.

In FIGS. 2 and 3, two bend sensors 205 and 206 are installed in a horizontal direction to the information terminal body. The purpose thereof is to detect which one of the left and right sides of the information terminal is bent. When the bend sensor itself has a function to detect a bend position, one bend sensor may be used.

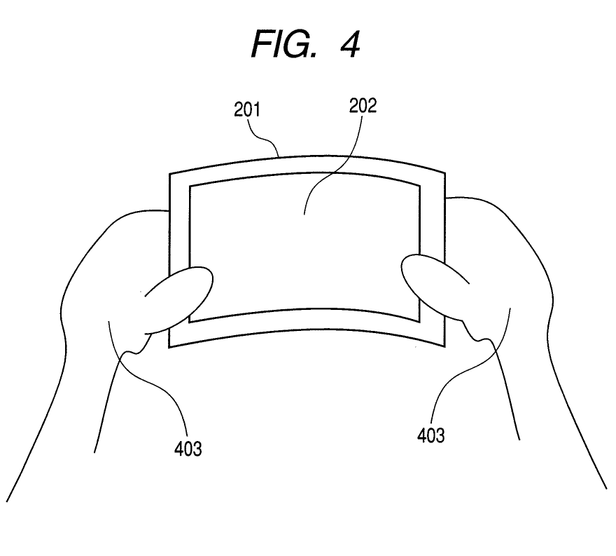

FIG. 4 illustrates a state in which the information terminal shown in FIGS. 2 and 3 are bent and held. Reference numeral 201 represents the portable terminal body, reference numeral 202 represents the display, and reference numeral 403 represents a hand holding the portable terminal body 201.

Hereinafter one detailed example of a content browsing method in the portable information terminal using the interface according to the embodiment of the present invention will be described. Herein, a case in which photographs, moving picture thumbnail, jacket photographs of music CDs, or the like is scrolled in a horizontal direction of the screen will be described as an example.

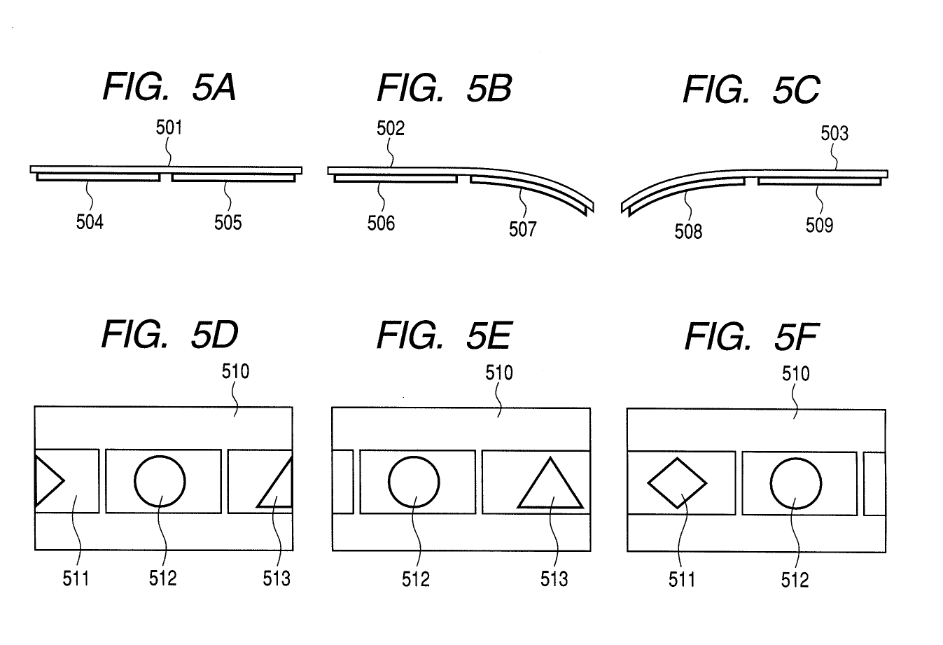

FIGS. 5A to 5F illustrate a cross-sectional view of the portable information terminal that is composed of the flexible display and body shown in FIGS.2 and 3 viewed from a horizontal direction to a display surface and illustrate a screenshot of the portable information terminal viewed in a direction facing the display surface. FIGS. 5A, 5B, and 5C illustrate the cross-sectional views and FIGS. 5D, 5E, and 5F illustrate the screenshots.

In the figures, reference numerals 501, 502, and 503 represent all parts other than the bend sensor, such as the display, the body, etc. In the figures, reference numerals 504, 505, 506, 507, 508, and 509 represent the bend sensors.

Further, reference numeral 510 represents the display of the terminal, and reference numerals 511, 512, and 513 represent the still images, the moving pictures, or the CD jacket photographs of music files, etc. that is displayed on the display.

FIGS. 5A and 5D illustrate a state in which the terminal is not bent, FIGS. 5B and 5E illustrate a state in which the right side of the terminal is bent, and FIGS. 5C and 5F illustrate a state in which the left side of the terminal is bent. The bend sensors 504, 505, 506, 507, 508, and 509 acquire the bending condition as an electric resistance value. The bend sensors acquire a small resistance value when the bending magnitude is small and a large resistance value when the bending magnitude is large, and transmit the resistance values to the CPU 106 (shown in FIG. 1) of a microcontroller or a PC, etc. The bending condition may be reflected to an operation of a graphical user interface displayed on the display by performing a processing in accordance with the magnitude of the resistance value transmitted from the CPU 106. For example, when the terminal body 501 is not bent but flat, the bend sensors 504 and 505 are not also bent. Resistance value of the bend sensors 504 and 505 are equal to or less than a predetermined threshold. In this case, the images 511, 512, and 513 that are displayed on the display 510 are not scrolled in any one of the left and right directions and a target image, for example, the image 512 can be accessed. When the right side of the terminal body 502 is bent (as shown in FIG. 5), the resistance values of the left bend sensor 506 is small as it is while the resistance value of the right bend sensor 507 increases, such that values larger than the predetermined threshold are transmitted to the CPU. In this case, the images 511, 512, and 513 that are displayed on the display 510 are right-scrolled (move in a left direction) In the state shown in FIG. 5D, the image 512 displayed in the center moves left and the image 513 moves to the center. Meanwhile, when the left side of the terminal body 503 is bent (as shown in FIG. 5C), the resistance value of the right bend sensor 509 is small at it is while the resistance value of the left bend sensor 508 increases, such that values larger than the predetermined threshold are transmitted to the CPU. In this case, the images 511, 512, and 513 that are displayed on the display 510 are left-scrolled (move in a right direction). In the state shown in FIG. 5D, the image 512 displayed in the center moves right and the image 511 moves to the center.

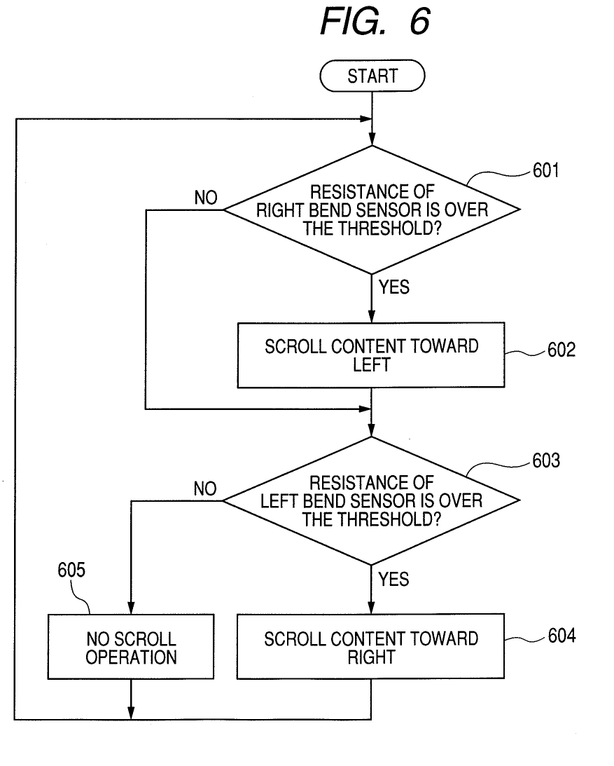

FIG. 6 is a flowchart when still images, moving picture thumbnails, CD jacket photographs of music files, etc. are scrolled by using the terminal with the flexible display described in FIGS. 2, 3, and 5A to 5F. The sensor information reading unit 106 always receives an input from the bend sensors (for example, 205 and 206 of FIG. 2) for detecting the bending of the left and right sides of the terminal 201 and transmits a determination result concerning the magnitude in the CPU 106 to the browsing program 109. The browsing program 109 determines whether an input value from the right bend sensor is larger than the threshold (step S601) and if the input value is larger than the threshold, the image moves (right-scrolls) in a left direction (step S602). Next, although the input value from the right bend sensor is larger than the threshold or not larger than the threshold, the browsing program 109 determines whether an input value from the left bend sensor is larger than the threshold (step S603). When the input value is larger than the threshold, the browsing program 109 moves (left-scrolls) the image in a right direction (step S604). When the input value is not larger than the threshold, the browsing program 109 does not scroll the image (step S605). As known in the flowchart, when the input values from the left and right bend sensors are not larger than the threshold, the image displayed on the display is not scrolled in any direction. By managing the detection values of the bend sensor by the threshold, it is possible to discriminate a case in which the scrolling is performed by intentionally bending the display unit from a case in which the terminal device is just being held.

As clearly described above, the interface according to the embodiment of the present invention determines which one of the left and right sides of the terminal is bent by using the input values from two bend sensors attached to the left and right sides of the terminal body and decides a scrolling direction of the image displayed on the display in accordance with the result. Further, since the input values from the bend sensors continuously vary depending on a bending magnitude, it is possible to perform the scrolling at a high speed by bending the terminal largely and perform the scrolling at a low speed by bending the terminal a little. In addition, since the terminal body including the display is bent at the time of performing the scrolling operations, it is possible to feel elastic force when the terminal is bent and held by hands depending on the bending magnitude. As a result, it is possible to acquire a sensory feedback in scrolling, which cannot be acquired in a known button operation or a known touch panel operation.

Moreover, referring to FIG. 2, in the interface according to the embodiment of the present invention, it is possible to give feedback by a sound and feedback by vibration to the tip of a finger or the hand by generating a short explosive sound or pulse wave from the speakers 207 and 208 that are attached to the display 202 whenever one image is moved at the time of performing the scrolling operation.

As described above, it is possible to perform scrolling the image on the screen by giving the feedback using the elastic force, the vibration, or the sound and bending the terminal, and it is possible to acquire an effect to arbitrarily turn over the pages of the actual book. That is, the book is bent and held at a predetermined degree in order to turn over the pages at the time of operating the book in the real world and the turning over speed of the pages is arbitrarily controlled while adding or subtracting power to press the pages by the tip of the finger, or adjusting the bending magnitude. Similarly, it is possible to access the digital contents by using the interface according to the embodiment of the present invention.

Next, when it is possible to access the digital contents by using the interface according to the embodiment of the present invention, a method for storing liked contents and displaying the contents at any time will be described.

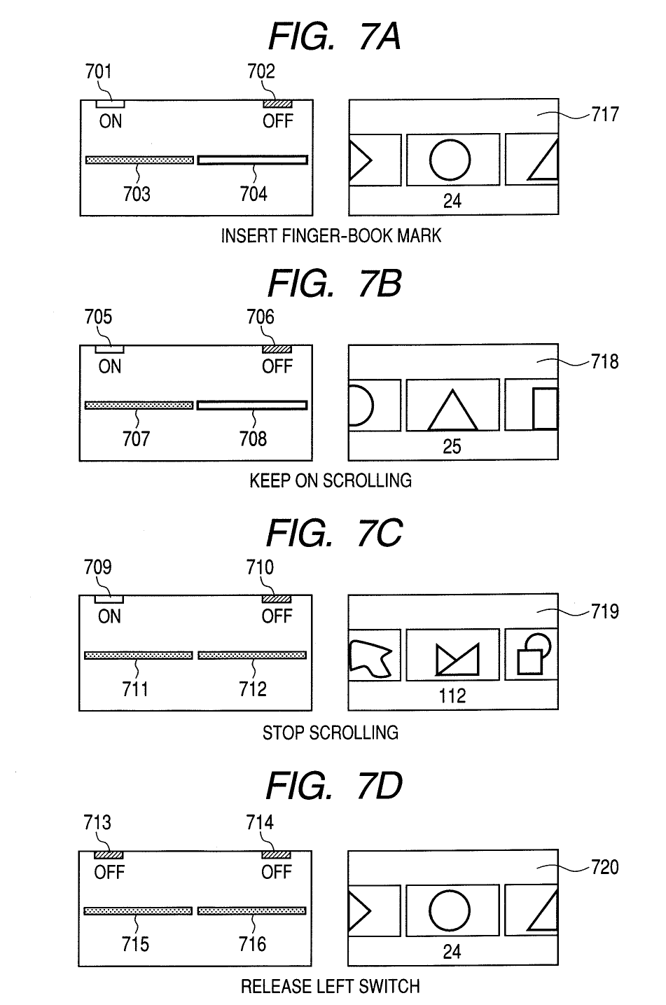

FIGS. 7A to 7D are diagrams illustrating a bookmark function using the interface according to an embodiment of the present invention. Reference numerals 701, 702, 705, 706, 709, 710, 713, and 714 represent buttons or switches that are installed on the lower cover (303 shown in FIG. 3) of the rear surface of the display. Reference numerals 703, 704, 707, 708, 711, 712, 715, and 716 represent bend sensors that are installed on the lower cover (303 shown in FIG. 3) of the rear surface of the display. Reference numerals 717, 718, 719, and 720 represent examples of the images displayed on the display (302 shown in FIG. 3). The operation members such as the buttons or the switches that are provided for the “bookmark function” are disposed outside of the area of the display unit so as not to influence the scrolling operation of the display information, that is, may be disposed in an area which can be operated by a finger that does not contribute to the bending operation independently from the bending operation of the display unit, i.e., a forefinger. In an initial state, the buttons or switches 701, 702, 705, 706, 709, 710, 713, and 714 are not pressed and thus is in an OFF state. In FIGS. 7A to 7D, the scrolling is performed in the right direction by bending the right side of the terminal. As a result, the bend sensors 704 and 708 that are installed at the left side of the terminal acquires resistance values equal to or larger than a predetermined threshold. While scrolling and accessing the images, for example, a twenty-fourth image is found and after all images are accessed, a twenty-fourth photograph is displayed again. In case of performing this operation, when the twenty-fourth image is found during scrolling, the button or switch that is disposed at the left side of the terminal is pressed and thus is in an ON state (step S701). By this operation, the twenty-fourth image is memorized in the memory unit (108 shown in FIG. 1).

Next, in order to access another image, the scrolling is continuously performed in the right direction and the right side of the terminal is continuously bent. As a result, the right bend sensor 708 acquires a resistance value equal to or larger than the threshold. At this time, the scrolling is performed with the button or switch 707 that is disposed at the left side of the terminal pressed. A twenty-fifth image that is disposed at the right side of the twenty-fourth image is displayed on the display (step S718), and subsequently, the right image are scrolled to move in the left direction like the twenty-sixth and twenty-seventh images.

Herein, when the operation of bending the terminal is stopped (as shown in FIG. 7C), the right bend sensor 712 that acquires the resistance value equal to or larger than the threshold until then acquires a resistance value that is smaller than the threshold. As a result, scrolling the image displayed on the display is stopped. In the example of this figure, the scrolling is stopped during a step in which one hundred-twelfth image is displayed at the center. At this time, the button or switch 709 that is disposed at the left side of the terminal is pressed and thus is in an ON state as it is.

Lastly, when the left button or switch 713 is released and is then in the OFF state (as shown in FIG. 7D), the memorized twenty-fourth photograph is displayed on the display.

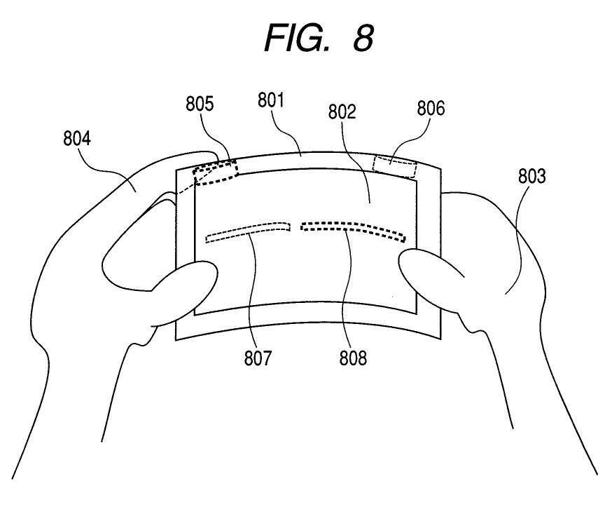

FIG. 8 illustrates the operation of the “bookmark function” described in FIGS. 7A to 7D. Reference numeral 801 represents the terminal body, reference numeral 802 represents the flexible display, reference numeral 803 represents a right hand, reference numeral 804 represents a left hand, reference numeral 805 represents the button or switch that is disposed at the left side of the terminal, reference numeral 806 represents the button or switch that is disposed at the right side of the terminal, reference numeral 807 represents the left bend sensor, and reference numeral 808 represents the right bend sensor. FIG. 8 illustrates an operation of performing right scrolling with the bookmark placed at an liked image by bending the right side of the terminal and pressing the left button or switch. That is, FIG. 8 illustrates a state in which the left button or switch 805 is in the ON state and the right bend sensor 808 acquires the resistance value equal to or larger than the threshold.

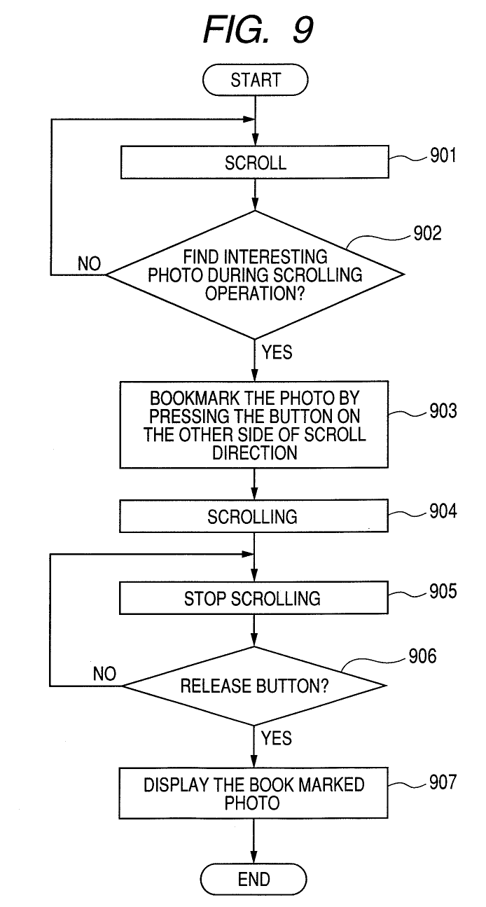

FIG. 9 is a flowchart illustrating the “bookmark function” described in FIGS. 7 and 8. Herein, the image is scrolled by bending the terminal (step S901). When a liked image is found during scrolling (step S902), a button or a switch that is disposed opposite to the scrolling direction is pressed (step S903). For example, when a liked photograph is found in the middle of right-scrolling by bending the right side of the terminal, the left button or switch is pressed. By this operation, the image is memorized. When the terminal is bent and held, the scrolling is continued (step S904). When the scrolling is stopped by stopping the bending of the terminal (step S905) and releasing the pressed button (step S906), the memorized image is displayed (step S907). The memorized photograph is not displayed but the image at the time of stopping the scrolling is displayed with the button pressed.

As clearly described shown in FIGS. 7A to 7D, 8, and 9, by the interface according to the embodiment of the present invention, the image specified by the bookmark can be displayed when the scrolling operation is terminated by placing the bookmark in the liked image whenever the liked image is found without hindering the scrolling operation. Since memorizing (bookmark function) and scrolling (turning-over function by hands) of the liked image can be performed at the same time, a complicated operation such as pressing a plurality of buttons or searching liked contents from a bookmark list as described in the known method becomes unnecessary.

As described in FIGS. 7A to 7D, 8, and 9, since the liked image is memorized by turning on or off any one of the left and right buttons, only one image can be memorized, but when two or three left and right buttons or switches are installed, it is possible to activate the “bookmark function” for a plurality of contents with the terminal held by both hands.

The “bookmark function” described in FIGS. 7A to 7D, 8, and 9 is used as the bookmark by sticking the finger in a liked page in the middle of reading the actual book and the liked page can be opened at any time. This operation method is applied to an operation of accessing the digital contents in the portable information terminal with the flexible display and the body.

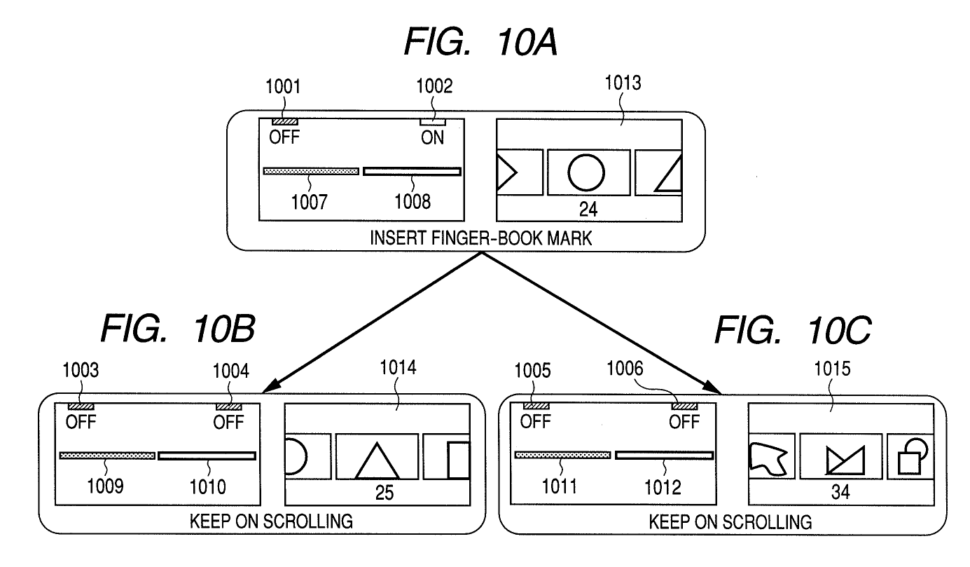

The easiest method for executing and stopping the scrolling at the time of accessing the digital contents by using the interface according to the embodiment of the present invention is to bend the information terminal body and the display themselves or to flatten the display by loosing power of a hand applied to bend the information terminal body and the display. Another method for stopping and restarting the scrolling will be described with reference to FIG. 10.

FIG. 10 is a diagram illustrating another example at the time of scrolling image contents by using the interface according to the embodiment of the present invention. Referring to this figure, the method for stopping and restarting the scrolling with the terminal body bent will be described. By this method, the scrolling is temporarily stopped in an area of a liked image during scrolling and after the image is checked, the scrolling can be restarted in the same direction. Although FIGS. 7A to 7D, 8, and 9 have illustrated the bookmark function to memorize the liked image, FIG. 10 illustrates a case in which the liked image is just checked and scrolling the contents is continued.

In FIG. 10, reference numerals 1001, 1002, 1003, 1004, 1005, and 1006 represent the buttons or switches, reference numerals 1007, 1008, 1009, 1010, 1011, and 1012 represent the bend sensors, and reference numerals 1013, 1014, and 1015 represent screenshots displayed on the display. In this figure, the scrolling of the image is performed in the right direction by bending the right side of the terminal. As a result, the left bend sensor 1007 acquires a resistance value equal to or smaller than the threshold and the right bend sensor 1008 acquires a resistance value equal to or larger than the threshold. The liked image is found while scrolling in the right direction (1013 of step (a)). In this figure, for example, the twenty-fourth image is set to the liked image. In this case, when the switch 1002 that is installed at the right side of the terminal is pressed without changing the bending magnitude, the right bend sensor 1008 acquires the resistance value equal to or larger than the threshold, but the right bend sensor 1008 may be mounted to stop the scrolling. When the switch 1004 that is disposed at the right side of the terminal is turned off (1014 of step (b)) after the twenty-fourth image is checked, the right bend sensor 1010 acquires the resistance value equal to or larger than the threshold, such that the scrolling is restarted, for example, the twenty-fifth image moves to the vicinity of the center.

As described above, the interface according to the embodiment of the present invention can change the scrolling speed depending the bending magnitude. When the scrolling is released from a state in which the scrolling is stopped and turned off by pressing the switch 1002 (1004 of step (b)), the bending magnitude is not large, but when the right bend sensor acquires the resistance value equal to or larger than the threshold (1010 of step (b)), the image is scrolled at a low speed and one the twenty-fifth right image moves to the center after a predetermined time (for example, one second) elapses (1014 of step (b)). Meanwhile, when the switch 1002 is pressed and thus is turned off by releasing the scrolling from the state in which the scrolling is stopped (1006 of step (c)), the image is scrolled at a high speed and ten thirty-fourth right images move to the center after the predetermined time (for example, one second) elapses (1015 of step (c)) in a case in which the right bend sensor acquires the resistance value equal to or larger than the threshold so that the bending magnitude is large (1012 of step (c)).

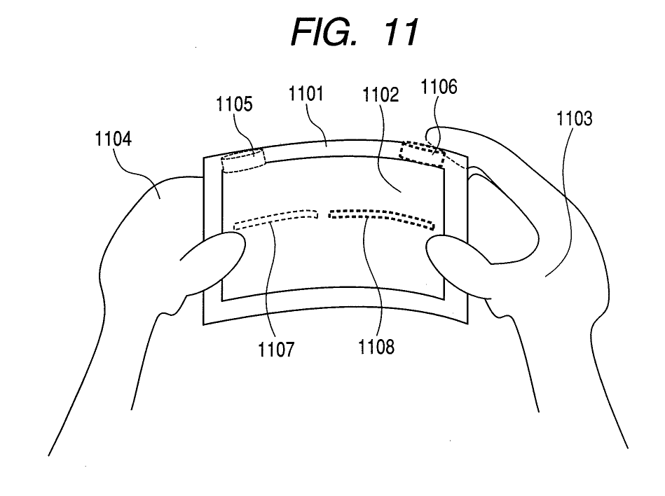

FIG. 11 is a diagram illustrating a state in which a terminal is held when the image contents are scrolled as described in FIG. 10 by using the interface according to the embodiment of the present invention. Reference numeral 1101 represents the terminal body, reference numeral 1102 represents the flexible display, reference numeral 1103 represents the right hand, reference numeral 1104 represents the left hand, reference numeral 1105 represents the button or switch that is disposed at the left side of the terminal, reference numeral 1106 represents the button or switch that is disposed at the right side of the terminal, reference numeral 1107 represents the left bend sensor, and reference numeral 1108 represents the right bend sensor.

FIG. 11 illustrates a state in which the right scrolling is stopped with the liked image displayed by bending the right side of the terminal and pressing the right button or switch. That is, FIG. 11 illustrates a state in which the right button or switch 1106 is in the ON state and the right bend sensor 1108 acquires the resistance value equal to or larger than the threshold. When the right button 1106 is turned off, the right bend sensor 1108 acquires the resistance value equal to or larger than the threshold, whereby the right scrolling is restarted.

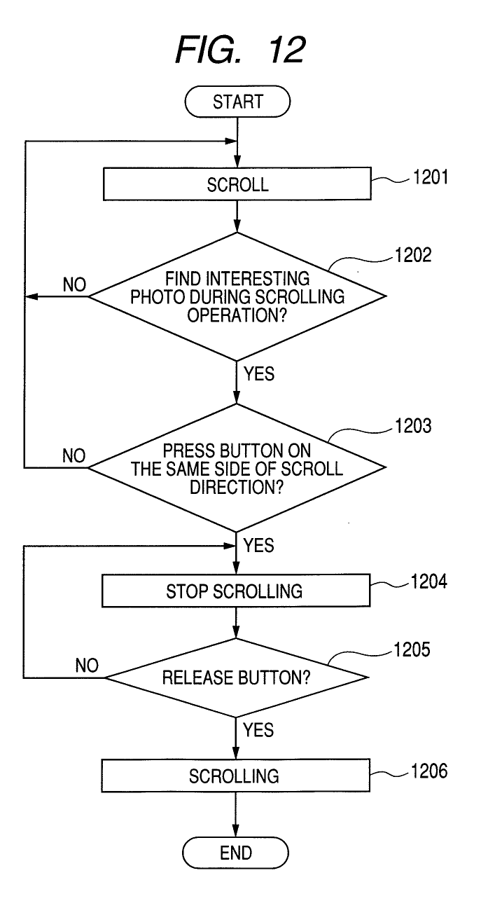

FIG. 12 is a flowchart illustrating the stopping and restarting of the scroll described in FIGS. 10 and 11. Herein, a case in which the image is scrolled by bending the terminal will be described as an example. (step S1201). When the liked image is found during scrolling (step S1202), a button or a switch that is disposed at the same side as the scrolling direction is pressed (step S1203). For example, when the liked photograph is found in the middle of right-scrolling by bending the terminal right, the right button or switch is pressed. Therefore, the scrolling is stopped with the image displayed (step S1204). When the pressed button is released (step S1205), the right scrolling is restarted (step S1206). In a case in which a subsequent image is displayed without pressing the button at the same side as the scrolling direction when the liked image is found during scrolling (step S1202), the scrolling is performed until the image is displayed by bending the terminal opposite to the scrolling direction.

As clearly described shown in FIGS. 10, 11, and 12, by the interface according to the embodiment of the present invention, the scrolling operation is terminated whenever the liked image is found without hindering the scrolling operation. Since the scrolling may be stopped while performing the bending operation of the terminal for performing the scrolling, the stop and the restart of the scroll can be smoothly switched to each other.

Even in the known method, for example, the scrolling is performed by pressing the button for a predetermined period and when the liked image is found, the scrolling can be stopped by releasing the button. In case of the method of pressing the button for a long time, the scrolling is performed at a low speed at the time of the long-time pressing is started, the scrolling is accelerated and the scrolling is performed at a predetermined speed faster than an initial speed as the long pressing is continued. However, in this method, when the scrolling is restarted once the scrolling is stopped, the scrolling is restarted at the initial speed. Therefore, when all digital contents of a predetermined quantity are accessed at once, the operation may pause.

Contrary to this, the initial speed when the scrolling is restarted after the scrolling is stopped can be determined in accordance with the bending magnitude of the terminal by using the method according to the embodiment of the present invention, which is described in FIGS. 10, 11, and 12. That is, it is possible to perform the content access that the scrolling is temporarily stopped on the liked image while accessing a predetermined quantity of contents at once and then all the contents are again accessed by the method according to the embodiment of the present invention.

A function to smoothly perform the stop and the restart of the scroll, which is described in FIGS. 10, 11, and 12 is acquired by embodying an operation method in which when a liked page is found during lightly reading the actual book, the turning-over of the page is suppressed by giving force to a finger holding the page and the turn-over of the page is restarted by releasing the tip of the finger after checking the liked page in accessing the digital contents in the portable information terminal with the flexible display and body.

In case of the actual book, the page is bent to some degree and is held even while turning over the page is stopped. When the turning-over the page is restarted by releasing the tip of the finger, the speed of the turned-over pages or the number of turned-over pages depends on the bending magnitude. The function to smoothly perform the stop and the restart of the scroll, which are described in FIGS. 10, 11, and 12 is acquired by similarly copying the way to handling the actual book in respects to accessing the digital contents in the portable information terminal with the flexible display and body.

What is claimed is:

1. An information display terminal, comprising:
a flexible display unit that displays information and is configured to be flexible;
bend sensors that is incorporated in the display unit and detect a bending degree by bending the display unit; and
an image display control unit that controls a scrolling speed of the information displayed on the display unit in accordance with a detection output of the bend sensor,
wherein a page turn-over display of the information is performed at the scrolling speed in accordance with the bending degree of the display unit.

2. The information display terminal according to claim 1, further comprising:
a communication unit that receives external information via the Internet.

3. The information display terminal according to claim 1, wherein an operation member for memorizing the information displayed on the display unit at the time of operation is provided outside of an area of the display unit.

4. The information display terminal according to claim 1, further comprising:
a audio output unit that outputs sounds having different pitches depending on the scrolling speed.

5. The information display terminal according to claim 1, wherein the bend sensors are installed parallel to each other to detect which side of left and right sides of the terminal.

6. The information display terminal according to claim 3, wherein the display at the scrolling speed depending on the bending degree during a first operation by the operation member is continuous and the information memorized at the time of the operation is displayed on the display unit when the first operation is terminated.

7. The information display terminal according to claim 3, wherein the display at the scrolling speed depending on the bending degree by the first operation performed by the operation member is stopped and the information designated by the first operation is displayed on the display unit.

8. The information display terminal according to claim 7, wherein the display at the scrolling speed depending on the bending degree is restarted when the first operation is terminated.

9. An interface for information display, wherein the interface is used for an information display terminal that includes a flexible display unit that displays information and is configured to be flexible; bend sensors that are incorporated in the display unit and detect a bending degree by bending the display unit; and an image display control unit that controls a scrolling speed of the information displayed on the display unit in accordance with a detection output of the bend sensor, and performs a page turn-over display of the information at the scrolling speed depending on the bending degree of the display unit.
